(19) United States
(12) Patent Application Publication
(10) Pub. No.: US 2004/0110076 A1
(43) Pub. Date: Jun. 10, 2004

(54) Magnetic toner

(76) Inventors: Katsuhisa Yamazaki, Shizuoka (JP); Hiroshi Yusa, Tokyo (JP); Takashige Kasuya, Shizuoka (JP); Yoshihiro Ogawa, Shizuoka (JP); Hideto Iida, Shizuoka (JP); Syuhei Moribe, Shizuoka (JP)

Correspondence Address: FITZPATRICK CELLA HARPER & SCINTO, 30 ROCKEFELLER PLAZA, NEW YORK, NY, 10112, US

(21) Appl. No.: 10/671,618

(22) Filed: Sep. 29, 2003

(30) Foreign Application Priority Data
Sep. 27, 2002 (JP) 2002-282761(PAT.)

(51) Int. Cl. G03G 9/083

(52) U.S. Cl. 430/106.2; 430/109.4

(57) ABSTRACT

To provide a toner including at least a binder resin and magnetic iron oxide, in which the magnetic iron oxide contains 0.1 to 2.0% by mass of Si with respect to the magnetic iron oxide and 0.1 to 4.0% by mass of Zn with respect to the magnetic iron oxide, a concentration of Si atoms is 12.50 to 17.50%, a concentration of Fe atoms is 70.00 to 85.00%, and a concentration of Zn atoms is 1.00 to 7.00% on an outermost surface of the magnetic iron oxide, measured by an X-ray photoelectron spectroscopy (XPS), and a Zn/Si ratio being 0.05 to 0.5, a Fe/Si ratio being 3.00 to 7.00, and a Fe/Zn ratio is 10.00 to 70.00 on an outermost surface of the magnetic iron oxide. As a result, a magnetic toner in which the rising of the toner charge amount is rapid, the degradation of image quality and reduction in image density are not caused even after a long-term use, and which is excellent in environmental stability can be obtained.

### BACKGROUND OF THE INVENTION

1. Field of the Invention

The present invention relates to an image forming method for visualizing an electrophotograph and an electrostatic charge image, and to a magnetic toner for development to be used for a toner jet.

2. Description of the Related Art

U.S. Pat. No. 4,395,476 and U.S. Pat. No. 4,473,627 propose a jumping development method. According to this method, a magnetic toner is applied extremely thinly on a sleeve and triboelectrificated. Then, a magnetic toner layer on the sleeve is brought into contact with an electrostatic latent image to develop an image.

In the jumping development using magnetic toner, when a developing device is set so that an image density is sufficiently high, excess toner is developed, which may degrade image quality and fogging, and increase the consumption amount of toner.

In order to reduce the consumption amount of toner, it is important that the toner charge amount is highly controlled with a magnetic body that is exposed to the surfaces of toner particles to function as a leak site for charging, whereby the magnetic brush of the toner on the sleeve is controlled.

Conventionally, as a magnetic iron oxide contained in a magnetic toner, U.S. Pat. No. 4,820,603 and U.S. Pat. No. 4,975,214 propose a magnetic toner containing magnetic iron oxide including silicon. In such magnetic iron oxide silicon is actively allowed to be present in the magnetic iron oxide. However, magnetic toner containing the magnetic iron oxide have problems such as a degradation in a developing property after a long-term use.

JP 4-362954 A and JP 5-281778 A disclose magnetic iron oxide containing silicon and aluminum. These particles also cause problems such as degradation in a developing property and a consumption amount of toner after a long-term use under high-temperature and high-humidity environment. Furthermore, JP 8-050369 A discloses magnetic iron oxide defining the content and the magnetic characteristics of silicon present on the surface of magnetic iron oxide containing divalent metal atoms and iron atoms.

JP 9-59024 and JP 9-59025 describe magnetite particles containing 1.7 to 4.5 atomic % of silicon with respect to Fe converted in terms of Si and containing 0 to 10 atomic % of at least one metal element selected from the group consisting of Mn, Zn, Ni, Cu, Al, and Ti with respect to with respect to Fe.

Because of the above, the magnetic characteristics can be enhanced, and the chargeability can be improved. However, the consumption amount of toner cannot be reduced by merely adding the above-mentioned metal, so that there are still some points to be improved.

JP 11-157843 A discloses magnetite particles containing a silicon component continuously from the center to the surface of the magnetite particles, in which the silicon component is exposed to the surfaces of the particles, and the outer shell of the particles is coated with a metal compound composed of at least one metal component selected from the group consisting of Zn, Mn, Cu, Ni, Co, Cr, Cd, Al, Sn, Mg, and Ti. However, the problems regarding the degradation in image quality and developing property after a long-term use, and the consumption amount of toner are not sufficiently solved, so that there are still some points to be improved.

JP 11-316474 A, JP 11-249335 A, and JP 11-282201 A disclose magnetic iron oxide defining the content of at least one metal element selected from the group consisting of Mn, Zn, Ni, Cu, Co, Cr, Cd, Al, Sn, and Mg base on an iron element; the content of silicon element; the content ratio of silicon element present up to 20% by mass of an iron element solubility; and the content ratio of silicon element present up to 10% by mass of an iron element solubility.

Thus, by allowing various kinds of metals to be contained in magnetic iron oxide and defining the distribution of Si in magnetic iron oxide, the effect of enhancement of environmental stability is found; however, further improvement is desired with respect to the reduction in consumption amount of toner.

JP 11-189420 A discloses magnetite particles containing a silicon component and an aluminum component continuously from the center to the surfaces of the magnetite particles, in which the components are exposed to the surfaces of the particles, and the outer shells of the particles are coated with a metal compound composed of at least one metal component selected from the group consisting of Zn, Mn, Cu, Ni, Co, Cr, Cd, Al, Sn, Mg, and Ti, bonded to the silicon component and the aluminum component. However, sufficient charging stability is not still provided to magnetic toner.

JP 4-184354 A, JP 4-223487 A, and the like disclose a method of decreasing saturation magnetization of toner, for example, by replacing a divalent iron of magnetite with a divalent metal such as zinc and copper. However, the charging stability of toner and the reduction in consumption amount thereof can not be achieved by merely controlling the magnetic characteristics of a magnetic body and toner.

### SUMMARY OF THE INVENTION

Therefore, it is an object of the present invention to provide a magnetic toner in which the above-mentioned problems are solved.

More specifically, an object of the present invention is to provide a magnetic toner in which the rising of the charge amount of toner is rapid, the degradation of image quality and reduction in image density are not caused even after a long-term use, and which is excellent in environmental stability.

The present invention relates to a magnetic toner including at least a binder resin and a magnetic iron oxide, in which the magnetic iron oxide contains Si in an amount of 0.1 to 2.0% by mass with respect to the magnetic iron oxide and Zn in an amount of 0.1 to 4.0% by mass with respect to the magnetic iron oxide; a concentration of Si atoms is 12.50 to 17.50%, a concentration of Fe atoms is 70.00 to 85.00%, and a concentration of Zn atoms is 1.00 to 7.00% on an outermost surface of the magnetic iron oxide, measured by an X-ray photoelectron spectroscopy (XPS); and a Zn/Si ratio is 0.05 to 0.5, a Fe/Si ratio is 3.00 to 7.00, and a Fe/Zn ratio is 10.00 to 70.00 on an outermost surface of the magnetic iron oxide.

These and other advantages of the present invention will become apparent to those skilled in the art upon reading and understanding the following detailed description with reference to the accompanying figures.

### DETAILED DESCRIPTION OF THE PREFERRED EMBODIMENTS

The inventors of the present invention studied a material for constituting toner, and found that, in particular, the concentration of iron, zinc, and silicon on the outermost surface of magnetic iron oxide, and the ratio of the respective atoms are closely related to the rising of the charge amount of toner, developing property, environmental stability, and image quality.

That is, the inventors of the present invention found the following. In a magnetic toner that contains at least a binder resin and a magnetic iron oxide, the magnetic iron oxide containing Si in amount of 0.1 to 2.0% by mass with respect to the magnetic iron oxide and Zn in an amount of 0.1 to 4.0% by mass with respect to the magnetic iron oxide, a concentration of Si atoms being 12.50 to 17.50%, a concentration of Fe atoms being 70.00 to 85.00%, and a concentration of Zn atoms being 1.00 to 7.00% on the outermost surface of the magnetic iron oxide measured by X-ray photoelectron spectroscopy (XPS), and a Zn/Si ratio being 0.05 to 0.50, a Fe/Si ratio being 3.00 to 7.00 and a Fe/Zn ratio being 10.00 to 70.00 on the outermost surface of the magnetic iron oxide, the rising of a charge amount is enhanced, high image quality is obtained stably even when used under the conditions of high humidity or low humidity, and an image defect is not caused with the passage of time.

The magnetic iron oxide used in the present invention preferably contains 0.1 to 4.0% by mass of Zn, more preferably 0.1 to 2.0% by mass, with respect to the magnetic iron oxide.

The magnetic iron oxide containing Zn is excellent in balance such as an exposure degree of magnetic iron oxide to the surfaces of toner particles, and the charge amount of toner can be retained in high condition irrespective of the environment. Furthermore, the magnetic iron oxide containing Zn is capable of controlling the toner charge amount distribution to be narrow. Consequently, it is possible to form thin and short bristle on a toner carrier at high density, and the performance of high image density is obtained with high image quality (reproducibility of dot, etc.).

When the content of Zn is less than 0.1% by mass, the electric resistance of the magnetic iron oxide itself is decreased to make it difficult to retain the charge amount of toner in an environment such as high temperature and high humidity, which leads to a decrease in image density on boot-up. When the Zn content is less than 0.1% by mass, the magnetic iron oxide is unlikely to be exposed to the surfaces of toner particles, which is likely to cause a decrease in image density by and an increase in fogging due to charge-up. Furthermore, when the Zn content is larger than 4.0% by mass, the electric resistance of the magnetic iron oxide itself is increased too much, and fogging is likely to be increased. Moreover, since the rising speed of the charge amount of toner is slow, the distribution of the charge amount of toner is likely to be broad. As a result, the magnetic brush of toner is nonuniform on a toner carrier, and the dot reproducibility and scattering of toner onto paper are likely to be degraded. Herein, boot-up refers to a state immediately after a power is turned on after a power has been turned off for a certain period of time.

Further, the magnetic iron oxide used in the present invention preferable contains 0.1 to 2.0% by mass of Si, more preferably 0.3 to 1.8% by mass, with respect to the magnetic iron oxide.

When the Si content is less than 0.1% by mass, the desired charge amount of toner cannot be obtained and the rising of the charge amount of toner is slow. Therefore, image density is likely to be decreased. When the Si content is larger than 2.0% by mass, the charge amount of toner is too high, so that a decrease in image density and an increase in fogging due to charge-up are likely to be caused.

According to the present invention, by allowing Zn and Si to be present simultaneously at a certain ratio on the outermost surface of magnetic iron oxide, the balance between the chargeability and the electric resistance of the magnetic iron oxide is kept. Thus, the magnetic iron oxide is capable of controlling the charge amount of toner. As a result, high image density and developing property of high image quality can be obtained irrespective of the environment.

That is, in the magnetic iron oxide according to the present invention, a concentration Si atoms is 12.50 to 17.50%, more preferably 12.50 to 17.00%, a concentration Fe atoms 70.00 to 85.00%, more preferably 75.00 to 85.00%, a concentration Zn atoms 1.00 to 7.00%, more preferably 1.00 to 6.00% on the outermost surface of the magnetic iron oxide, measured by X-ray photoelectron spectroscopy (XPS), and a Zn/Si ratio is 0.05 to 0.50, more preferably 0.05 to 0.40, a Fe/Si ratio is 3.00 to 7.00, more preferably 4.00 to 7.00, and a Fe/Zn ratio is 10.00 to 70.00, more preferably 10.00 to 65.00 on the outermost surface of the magnetic iron oxide.

When the concentration of Si atoms on the outermost surface of the magnetic iron oxide is less than 12.50%, the desired charge amount of toner cannot be obtained, and the rising of the charge amount is slow. Therefore, image density is likely to be decreased. When the concentration of Si atoms on the outermost surface is more than 17.50%, the charge amount of toner is too high, so that a decrease in image density and an increase in fogging due to charge-up are likely to be caused. Furthermore, when the concentration of Fe atoms on the outermost surface is less than 70.00%, the electric resistance of the surface of magnetic iron oxide itself is decreased, and the charge amount of toner is unlikely to be retained in an environment such as high temperature and high humidity, which leads to a decrease in image density on boot-up. When the concentration of Fe atoms on the outermost surface is more than 85.00%, the rising speed of the charge amount of toner is slow. Therefore, the distribution of the charge amount of toner is likely to be broad, and the magnetic brush of toner on a toner carrier is nonuniform, which may degrade the dot reproducibility and scattering of toner onto paper.

When the concentration of Zn atoms on the outermost surface of the magnetic iron oxide is less than 1.00%, the electric resistance of the surface of the magnetic iron oxide itself is decreased to make it difficult to retain the charge amount of the toner in an environment such as high temperature and high humidity, which leads to a decrease in image density on boot-up. Further, when the concentration of Zn atoms on the outermost surface is less than 1.00%, the magnetic iron oxide is unlikely to be exposed to the surfaces of toner particles, which is likely to cause a decrease in image density and an increase in fogging due to charge-up. Furthermore, when the concentration of Zn atoms on the outermost surface is larger than 7.00%, the electric resistance of the surface of the magnetic iron oxide is increased too much, and fogging is likely to be increased.

When the Zn/Si ratio on the outermost surface of the magnetic iron oxide is less than 0.05, the charge amount of the toner is increased. However, the electric resistance of the surface of the magnetic iron oxide itself is decreased, causing decrease in image density due to charge-up as well as difficulty in retaining the charge amount of toner in an environment such as high temperature and high humidity. As a result, decrease in image density on boot-up is caused. When the Zn/Si ratio on the outermost surface of magnetic iron oxide is larger than 0.50, the rising of the charge amount is slow. The electric resistance of the surface of the magnetic iron oxide is increased too much, so that fogging is likely to be increased.

When the Fe/Si ratio on the outermost surface of the magnetic iron oxide is less than 3.00, the charge amount of toner is increased. However, the electric resistance of the surface of the magnetic iron oxide itself is decreased, causing a decrease in image density due to charge-up, and difficulty in retaining the charge amount of toner in an environment such as high temperature and high humidity. As a result, decrease in image density on boot-up is caused. When the Fe/Si ratio on the outermost surface of magnetic iron oxide is larger than 7.00, the desired charge amount of toner cannot be obtained, and the rising of the charge amount is slow. Therefore, image density is likely to be decreased. Furthermore, since the rising speed of the charge amount of toner is slow, the distribution of the charge amount of toner is likely to be broad, and the magnetic brush of toner is nonuniform on a toner bearing unit, which may degrade dot reproducibility and scattering of toner onto paper.

Furthermore, when the Fe/Zn ratio on the outermost surface of magnetic iron oxide is less than 10.00, the electric resistance of the surface of magnetic iron oxide itself is increased too much, so that fogging is likely to be increased. When the Fe/Zn ratio on the outermost surface of magnetic iron oxide is larger than 70.00, the electric resistance of the surface of the magnetic iron oxide itself is decreased, and the charge amount of toner is difficult to be retained in an environment such as high temperature and high humidity, which leads to a decrease in image density on boot-up. Furthermore, the magnetic iron oxide is unlikely to be exposed to the surfaces of toner particles. Consequently, a decrease in image density and an increase in fogging due to charge-up are likely to be caused.

Thus, in the case where the configuration of atoms on the outermost surface of a magnetic iron oxide is out of the above range, the balance between the electric resistance and the chargeability of the magnetic iron oxide itself is not kept, which leads to a decrease in image density, degradation in fogging, and degradation in dot reproducibility and scattering of toner onto paper. In conventional metal addition type of magnetic iron oxide, the balance between the chargeability and the electric resistance is balanced by allowing a certain amount of a metal (e.g., zinc, aluminum, manganese, etc.) and silica to be present on the surface of the magnetic iron oxide. Therefore, the concentration of Fe atoms on the outermost surface of the magnetic iron oxide is decreased, and as a result, a Fe/Si ratio and a Fe/Zn ratio on the outermost surface of the magnetic iron oxide are decreased. Furthermore, in conventional metal addition type of magnetic iron oxide, after a metal is added, the magnetic iron oxide is coated with silica to keep a balance between the chargeability and the electric resistance. By coating the outermost surface of a magnetic material with silica, the concentration of metal atoms (zinc, etc.) on the outermost surface of the magnetic iron oxide is decreased.

The magnetic iron oxide according to the present invention does not have a configuration in which the surface of magnetic iron oxide is coated with another element or in which the composition of the outermost surface of the magnetic iron oxide is biased to one element, unlike the conventional metal addition type of magnetic iron oxide. Therefore, the amount of iron element present on the surface is maintained constant. Thus, in the composition on the outermost surface of the magnetic iron oxide, the balance of the composition ratio among silica, iron, and zinc is well kept. Therefore, it is possible to provide toner in which the balance between the chargeability and electric resistance well balanced, and which is particularly excellent in reproducibility of minute dots in an image requiring higher image quality, such as a half-tone image.

Next, the configuration of magnetic iron oxide used in the present invention and a method of producing the same will be described.

The magnetic iron oxide according to the present invention is produced, for example, by the following method. A predetermined amount of a metal salt of Zn, silicate, and the like is respectively added to a ferrous salt aqueous solution. Thereafter, an alkali such as sodium hydroxide is added in an equivalent or more with respect to an iron component to prepare an aqueous solution containing ferrous hydroxide. Air is blown into the prepared aqueous solution while the pH of the aqueous solution is maintained at 7 or higher (preferably, pH 8 to 10). An oxidation reaction of ferrous hydroxide is performed while the aqueous solution is heated to 70° C. or higher, whereby seed crystal to be a core of magnetic iron oxide is first produced.

Next, an aqueous solution containing one equivalent of ferrous sulfate with respect to the amount of previously added alkali is added to a slurry liquid containing the seed crystal. Thereafter, air is blown into the aqueous solution while the pH of the solution is maintained at 6 to 10, whereby the reaction of ferrous hydroxide is performed to grow magnetic iron oxide using the seed crystal as a core. In the magnetic iron oxide of the present invention having a feature of keeping a certain composition ratio of elements on the outer most surface of magnetic iron oxide constant, an oxidation reaction is performed step-by-step, in combination with the adjustment of pH. For example, the oxidation reaction is performed step-by-step in such a manner that pH is set to be 9 to 10 in an initial reaction, pH is set to be 8 to 9 in an intermediate reaction, and pH is set to be 6 to 8 in a later reaction, whereby the composition ratio on the outermost surface of the magnetic iron oxide can be controlled easily. The more the oxidation reaction proceeds, the more the pH of the solution is shifted to an acid side. However, it is preferable that the pH of the solution is not set to be less than 6.

As the metal salt to be added, other than iron, a sulfate, a nitrate, and a chloride may be used. Examples of silicate to be added include sodium silicate and potassium silicate.

As the ferrous salt, iron sulfate generally produced as a by-product in the course of production of titanium sulfate; iron sulfate produced as a by-product along with the washing of a surface of a copper plate; and iron chloride and the like may also be used.

A method for producing magnetic iron oxide according to the aqueous solution method is generally performed at 0.5 to 2 mol/l of an iron concentration in view of preventing an increase in viscosity during reaction as well as solubility of iron sulfate. In general, the lower the concentration of iron sulfate is, the smaller the particle size of a product is likely to become. During the reaction, the larger the amount of air and the lower the reaction temperature, the finer the particles are likely to become.

According to the above-mentioned production method, magnetic iron oxide hardly containing octahedral particles can be produced, in which magnetic iron oxide are composed of spherical particles formed of curved surfaces without having plate-shape surfaces in the observation of a transmission electron micrograph. It is preferable that such magnetic iron oxide is used as toner.

According to the present invention, the bulk density of the magnetic iron oxide, which is obtained based on the measurement method described later satisfies, preferably 0.3 to 2.0 g/cm³, and more preferably 0.5 to 1.3 g/cm³. When the bulk density is less than 0.3 g/cm³, the physical mixing of toner with other constituent materials in producing toner may be adversely affected, and the dispersibility of the magnetic iron oxide in a toner may be degraded.

According to the present invention, a number average particle size of the magnetic iron oxide, which is obtained based on the measurement method described later, is preferably 0.05 to 1.00 μm and more preferably 0.10 to 0.40 μm, which is desirable in terms of the dispersibility and uniform charging in a binder resin of a toner.

According to the present invention, it is preferable that a BET specific surface area of the magnetic iron oxide, which is obtained based on the measurement method described later, satisfies 15.0 m²/g or less and preferably 12.0 m²/g or less. When the BET specific surface area of magnetic iron oxide exceeds 15.0 m²/g, the moisture adsorptivity of the magnetic iron oxide is increased, which affects the hygroscopicity and chargeability of a toner containing the magnetic iron oxide.

According to the present invention, the magnetic iron oxide preferably has magnetic characteristics in which a saturation magnetization in a magnetic field of 795.8 kA/m is 10 to 200 Am²/kg, more preferably 70 to 100 Am²/kg; a residual magnetization is 1 to 100 Am²/kg, more preferably 2 to 20 Am²/kg; and coercive force is 1 to 30 kA/m, more preferably 2 to 15 kA/m. Because of such magnetic characteristics, a toner can exhibit a satisfactory developing property in which the balance between an image density and fogging is balanced.

According to the present invention, a toner contains magnetic iron oxide preferably in a range of 20 to 200 parts by mass, more preferably in a range of 30 to 150 parts by mass, with respect to 100 parts by mass of a binder resin.

When the content of the magnetic iron oxide is smaller than 20 parts by mass, the transportability is insufficient, so that nonuniformity is caused on a toner layer on a toner carrier, which may lead to nonuniformity of an image. When the content of the magnetic iron oxide exceeds 200 parts by mass, image density may be decreased.

According to the present invention, metal elements other than Fe, Zn, and Si may be present in the vicinity of the of magnetic iron oxide. In particular, it is preferable that Al elements are unevenly distributed in the vicinity of the surface of the magnetic iron oxide in terms of stabilization for producing magnetic iron oxide and the enhancement of the dispersibility of the magnetic iron oxide in a toner.

According to the present invention, the magnetic iron oxide may be treated with a silane coupling agent, a titanium coupling agent, and a surface treatment agent such as titanate, amino silane, or an organic silicon compound.

Hereinafter, the measurement method of various physical data in the present invention will next be described in detail.

(1) Analysis of the Outermost Surface of Magnetic Iron Oxide by X-Ray Photoelectron Spectroscopy (XPS)

According to the present invention, the composition ratio of metal elements on the outermost surface of the magnetic iron oxide can be obtained by the following method. For example, magnetic iron oxide powder is pressurized at 9.807 MPa by using a tablet forming unit to be formed into a pellet. The pellet is fixed on a carbon sheet on a sample holder and subjected to measurement. A measurement apparatus and measurement conditions are as follows.

An apparatus to be used: 1600S type X-ray photoelectron spectroscope produced by PHI

Measurement condition: X-ray source MgKα (400 W)

Analysis area: 0.8×2.0 mm

The concentration of surface atoms is estimated based on the measured peak strength of each element. The ratio of the respective atoms is calculated from the concentration of the atoms. For calculation of the surface atom concentration, a relative sensitivity factor provided by PHI is used. For calculation of the concentration of surface metal atoms, the atom concentration of all the metal atoms detected by the above measurement is converted to 100%, and thereafter, the concentration of each metal atom is calculated.

(2) Quantification of a Metal Element Amount Present in Magnetic Iron Oxide

According to the present invention, the content (with respect to the magnetic iron oxide) of metal elements other than iron in the magnetic iron oxide can be obtained by the following method. For example, about 3 liters of deionized water is placed in a 5-liter beaker, and heated in a water bath to 45° C to 50° C. Then, while about 25 g of the magnetic iron oxide that has been formed into a slurry with about 400 ml of deionized water is washed with about 300 ml of deionized water, the magnetic iron oxide is added to the 5-liter beaker together with the deionized water.

Then, while the temperature is kept at about 50° C., and a stirring speed is kept at about 3.33 s⁻¹, hydrochloric acid (special grade) or mixed acid of hydrochloric acid and hydrofluoric acid is added to start dissolution. At this time, an aqueous solution of hydrochloric acid is set to be about 3 mol/liter. From the commencement of dissolution until the time when all the components are dissolved to be transparent, about 20 ml of the solution is sampled several times, and filtered with a 0.1μ membrane filter to collect a filtrate. The filtrate is subjected to plasma emission spectroscopy (ICP) to quantify iron elements and the metal elements other than the iron element.

The content of the metal elements other than the iron metal with respect to magnetic iron oxide is calculated by the following expression.

Content of metal elements with respect to magnetic iron oxide (% by mass)=((c×d)/(e×1,000))×100

c: concentration of metal elements (mg/l) in the collected sample

d: Amount of the collected sample (l)

e: Weight of magnetic iron oxide (g)

(3) Bulk Density of Magnetic Iron Oxide

In the present invention, the bulk density of magnetic iron oxide is measured in accordance with a pigment test method of JIS-K-5101.

(4) Number Average Particle Size of Magnetic Iron Oxide

One hundred particles of magnetic iron oxide are selected optionally on a transmission electron microscope photograph (magnification: 3000), and the particle sizes thereof are measured. The average value of the particle sizes is determined as a number average particle size.

(5) Specific Surface Area of Magnetic Iron Oxide.

The surface of a sample is allowed to adsorb nitrogen gas by using a specific surface area measurement apparatus Autosorb l (produced by Yuasa Ionics Inc.), and a specific surface area can be calculated by using the BET multipoint method.

(6) Magnetic Characteristics of Magnetic Iron Oxide

Magnetic characteristics of the magnetic iron oxide can be measured under an external magnetic field of 795.8 kA/m, using Vibrating sample type magnetomer VSM-3s15 (produced by Toei Kogyo K.K.).

As the binder resin used in the present invention, various resin compounds conventionally known as binder resins may be used. For example, vinyl resin, phenol resin, natural resin modified phenol resin, natural resin modified maleic resin, acrylic resin, methacrylic resin, polyvinyl acetate, silicone resin, polyester resin, polyurethane, polyamide resin, furan resin, epoxy resin, xylene resin, polyvinyl butyral, terpene resin, coumaro-indene resin, and petroleum type resins can be given. Of those, polyester resin is preferably used as they have stable electrostatic property, good fludity and also excellent fixing property when used for toner.

Examples of the vinyl resin include polymers using vinyl monomers such as: styrene; styrene derivatives such as o-methylstyrene, m-methylstyrene, p-methylenestyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene and p-n-dodecylstyrene; ethylenically unsaturated monoolefins such as ethylene, propylene, butylene and isobutylene; unsaturated polyenes such as butadiene; vinyl halides such as vinyl chloride, vinylidene chloride, vinyl bromide and vinyl fluoride; vinyl esters such as vinyl acetate, vinyl propionate and vinyl benzoate; α-methylene aliphatic monocarboxylates such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate; acrylate esters such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate and phenyl acrylate; vinyl ethers such as vinyl methyl ether, vinyl ethyl ether and vinyl isobutyl ether; vinyl ketones such as vinyl methyl ketone, vinyl hexyl ketone and methyl isopropenyl ketone; N-vinyl compounds such as N-vinylpyrrole, N-vinylcarbazole, N-vinylindole and N-vinylpyrrolidone; vinylnaphthalins; acrylate or methacrylate derivatives such as acrylonitrile, methacrylonitrile and acrylamide; esters of α,β-unsaturated acids and diesters of dibasic acids; acrylic acid and α- or β-alkyl derivatives thereof such as acrylic acid, methacrylic acid, α-ethylacrylic acid, crotonic acid, cinnamic acid, vinyl acetic acid, isocrotonic acid and angelic acid; and unsaturated dicarboxylic acids such as fumaric acid, maleic acid, citraconic acid, alkenylsuccinic acid, itaconic acid, mesaconic acid, dimethylmaleic acid and dimethylfumaric acid, and monoester derivatives or anhydrides thereof. In the above vinyl resin, the vinyl monomers as previously mentioned may be used separately or two or more sorts thereof may also be used in combination. Of those, it is preferable that a combination of monomers which produce a styrene copolymer, or a styrene/acrylic copolymer be used.

Further, if required, the binder resin used in the present invention may be a polymer or copolymer cross-linked with a cross-linking monomer shown below.

A monomer having two or more cross-linkable unsaturated bonds may be used as the cross-linking monomer. As those types of cross-linking monomers, various monomers such as those shown below are conventionally known and may be applied to the toner of the present invention.

Examples of the cross-linking monomers include: aromatic divinyl compounds such as divinylbenzene and divinylnaphthalene; diacrylate compounds bonded with alkyl chains, such as ethylene glycoldiacrylate, 1,3-butylene glycol diacrylate, 1,4-butanediol diacrylate, 1,5-pentanediol diacrylate, 1,6-hexanediol diacrylate and neopentyl glycol diacrylate, and those obtained by changing the acrylate of the aforementioned compounds to methacrylate; diacrylate compounds bonded with alkyl chains each containing an ether bond, such as diethylene glycol diacrylate, triethylene glycol diacrylate, tetraethylene glycol diacrylate, polyethylene glycol #400 diacrylate, polyethylene glycol #600 diacrylate and dipropylene glycol diacrylate, and those obtained by changing the acrylate of the aforementioned compounds to methacrylate; diacrylate compounds bonded with chains each containing an aromatic group and an ether bond such as polyoxyethylene(2)-2,2-bis(4-hydroxyphenyl)propane diacrylate and polyoxyethylene(4)-2,2-bis(4-hydroxyphenyl)propane diacrylate, and those obtained by changing the acrylate of the aforementioned compounds to methacrylate; and polyester-type diacrylates such as MANDA (trade name) manufactured by Nippon Kayaku Co., Ltd.

Examples of the polyfunctional crosslinking agent include: pentaerythritol acrylate, trimethylolethane triacrylate, trimethylolpropane triacrylate, tetramethylolmethane tetraacrylate, oligoester acrylate, and those obtained by changing the acrylate of the above-mentioned compounds to methacrylate and triallyl cyanurate and triallyl trimellitate.

It is preferable that the use amount of these crosslinking agents is adjusted depending upon the kind of monomers to be cross-linked, desired physical properties of a binder resin, etc. In general, the crosslinking agents can be used in an amount of 0.01 to 10 parts by mass (more preferably 0.03 to 5 parts by mass) with respect to 100 parts by mass of other monomer components constituting a binder resin.

Among these cross-linking monomers, those which are preferably used in terms of fixing property and offset resistance for a resin of a toner (binder resin) include aromatic divinyl compounds (in particular, divinylbenzene), diacrylate compounds bound by a chain containing an aromatic group and an ether bond.

According to the present invention, a monopolymer or a copolymer of a vinyl monomer, polyester, polyurethane, epoxy resin, polyvinyl butyral, rosin, denatured rosin, terpene resin, phenol resin, aliphatic or alicyclic hydrocarbon resin, aromatic oil resin, and the like may be mixed with the above-mentioned binder resin, if required. In case two or more kinds of resins are mixed and used as a binder resin, it is preferable that resins having different molecular weights are mixed in an appropriate ratio.

Furthermore, the binder resin used in the present invention has a glass transition temperature preferably in a range of 45° C. to 80° C, more preferably 55° C. to 70° C.; a number average molecular weight (Mn) of 2,500 to 50,000; and a weight average molecular weight (Mw) of 10,000 to 1,000,000.

In general, the glass transition temperature of the binder resin can be adjusted by selecting a constituent material (polymerizable monomer) of the binder resin so that the theoretic glass transition temperature thereof, which is described in Polymer Handbook 2nd. Edition III-p139 to 192 (John Wiley & Sons), is 45° C. to 80° C. The glass transition temperature of the binder resin can be measured in accordance with ASTMD3418-82 by using a differential scanning calorimeter (e.g., DSC-7 produced by Perkin Elmer, DSC2920 produced by TA Instrument Japan). When the glass transition temperature of the binder resin is smaller than the above range, storage stability of toner may be insufficient. When the glass transition temperature of the binder resin is larger than the above range, the fixing property of toner may be insufficient.

No particular limitations are imposed on a method for synthesizing the binder resin composed of a vinyl polymer or a copolymer, and conventionally known various methods can be used. For example, a polymerization method such as mass polymerization, solution polymerization, suspension polymerization, or emulsion polymerization can be used. In the case of using a carboxylic acid monomer or an acid anhydride monomer, mass polymerization or solution polymerization is preferably used in terms of the property of the monomers.

As the binder resin used in the present invention, the following polyester resin are preferable. It is preferable that polyester resin contains an alcohol component in an amount of 45 to 55 mol % and acid components in an amount of 55 to 45 mol % in the entire components.

Examples of the alcohol component include ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, bisphenol derivatives represented by the following formula (B):

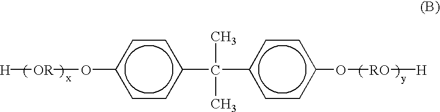

(wherein R represents an ethylene or propylene group, each of x and y is an integer number of 1 or more, and the mean value of x+y is 2 to 10.),

diols represented by the following formula (C):

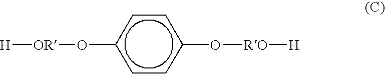

(wherein R represents —CH₂CH₂— or —CH₂—CH(CH₃)— or —CH₂—C(CH₃)₂—.) and polyhydric alcohols such as glycerin, sorbitol and sorbitan.

Further, a carboxylic acid is preferably shown as the acid component, and examples of the divalent carboxylic acid include: benzenedicarboxylic acids such as phthalic acid, terephthalic acid, isophthalic acid and phthalic anhydride or anhydrates thereof; alkyldicarboxylic acids such as succinic acid, adipic acid, sebacic acid and azelaic acid, or anhydrides thereof; and unsaturated dicarboxylic acids such as fumaric acid, maleic acid, citraconic acid and itaconic acid, or anhydrides thereof. Further, examples of a carboxylic acid with a valency of 3 or more include trimellitic acid, pyromellitic acid, benzophenonetetracarboxylic acid, and anhydrides thereof.

A particularly preferable alcohol component in polyester resin is a bisphenol derivative represented by the above-mentioned formula (B). Particularly preferable examples of an acid component include dicarboxylic acids such as phthalic acid, terephthalic acid, isophthalic acid, or anhydrides thereof, succinic acid, n-dodecenylsuccinic acid, or anhydrides thereof, fumaric acid, maleic acid, and maleic anhydride; and tricarboxylic acids such as trimellitic acid, or anhydrides thereof. A toner obtained by using polyester resin obtained from these acid components and alcohol components as a binder resin is preferable, since such toner has satisfactory fixing property and is excellent in offset resistance, when used as the toner for thermal roller fixing.

The acid value of polyester resin is preferably 1 to 100 mgKOH/g, and more preferably 1 to 50 mgKOH/g. The OH value (hydroxyl value) is preferably 50 mgKOH/g or less, and more preferably 30 mgKOH/g or less. When the number of end groups of a molecular chain is increased, the environment dependency is increased in charging characteristics of toner to change the flowability of toner, electrostatic adhesion and the surface resistance (effect of adsorbed water) of toner. Thereby, it may cause a decrease in image quality.

The glass transition temperature of polyester resin is preferably 50° C. to 75° C., and more preferably 55° C. to 65° C. Furthermore, the number average molecular weight (Mn) of polyester resin is preferably 1,500 to 50,000, and more preferably 2,000 to 20,000. The weight-average molecular weight (Mw) is preferably 6,000 to 100,000, and more preferably 10,000 to 90,000.

The magnetic toner of the present invention may contain wax.

Examples of the wax to be used in the present invention include: aliphatic hydrocarbon waxes such as low molecular weight polyethylene, low molecular weight polypropylene, polyolefin copolymer, polyolefin wax, microcrystalline wax, paraffin wax and Fisher-Tropsch wax; oxides of aliphatic hydrocarbon waxes such as oxidized polyethylene wax, or block copolymers thereof; plant waxes such as candelilla wax, carnauba wax, Japan tallow and jojoba wax; animal waxes such as bees wax, lanolin and spermaceti wax; mineral waxes such as ozokerite, ceresin and petrolatum; waxes mainly containing aliphatic esters such as montanic acid ester wax and caster wax; and partially or totally deoxidized aliphatic esters such as deoxidized carnauba wax. Furthermore, the examples include saturated straight-chain fatty acids such as palmitic acid, stearic acid, montanonic acid and a long-chain alkyl carboxylic acid having a longer-chain alkyl group; unsaturated fatty acids such as brassidic acid, eleostearic acid, and varinaline acid; saturated alcohols such as stearyl alcohol, eikosyl alcohol, behenyl alcohol, cownabil alcohol, ceryl alcohol, melissyl alcohol and an alkyl alcohol having a longer-chain alkyl group; polyhydric alcohols such as sorbitol; aliphatic amides such as linoleic amide, oleic amide and lauric amide; saturated aliphatic bisamides such as methylene bis-stearic amide, ethylene bis-capric amide, ethylene bis-laurylic amide and hexamethylene bis-stearic amide; unsaturated fatty acid amides such as ethylene bis-oleinic amide, hexamethylene bis-oleinic amide, N,N-dioleyladipinic amide and N,N-dioleylsebacic amide; aromatic bisamide such as m-xylene bis-stearic amide and N,N-distearylisophthalic amide; aliphatic metallic salts (generally referred to as metal soap) such as calcium stearate, calcium laurate, zinc stearate and magnesium stearate; wax obtained by grafting an aliphatic hydrocarbon wax using a vinyl monomer such as stylene or acrylic acid; a partially esterified compound of a fatty acid and a polyhydric alcohol such as monoglyceride of behenic acid; and methyl ester compound having a hydroxyl group obtained by the hydrogenation of vegetable oil.

A wax having a sharp molecular weight distribution, which is obtained by subjecting the above-mentioned wax to a press sweating method, a solvent method, a recrystallization method, a vacuum distillation method, a supercritical gas extraction method, or a melt crystallization method, is preferably used. Also, a wax from which an impurity such as a low molecular weight solid fatty acid, a low molecular weight solid alcohol, or a low molecular weight solid compound has been removed is preferably used.

Furthermore, according to the present invention, it is preferable that a charge controlling agent be added to control the toner into a negative charge type or a positive charge type. Specific examples of the negative charge controlling agent include: a metal complex of a monoazo dye described in JP 41-20153 B, JP 42-27596 B, JP 44-6397 B, JP 45-26478 B, or the like; nitrohumic acid and salt thereof described in JP 50-133838 A; a dye/pigment such as C.I.14645; metal complexes of Zn, Al, Co, Cr, Fe, Zr, etc. of salicylic acid, naphthoic acid, and dicarboxylic acid described in JP 55-42752 B, JP 58-41508 B, JP 58-7384 B, JP 59-7385 B, and the like; a sulfonated copper phthalocyanine pigment, a styrene oligomer with a nitro group or a halogen introduced thereto; and chlorinated paraffin. In particular, an azo-based metal complex represented by the general formula (I) and a basic organic acid metal complex represented by the general formula (II), which are excellent in dispersibility and have an effect on the stability of image density and reduction in fogging, are preferable.

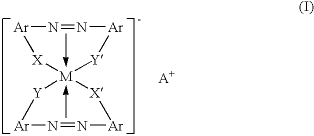

(wherein M represents a metal in the center of coordination, which is Cr, Co, Ni, Mn, Fe, Ti or Al. Ar is an aryl group such as a phenyl group or a naphtyl group, which may have a substituent. In this case, the substituent is a nitro group, a halogen group, a carboxyl group, an anilide group, an alkyl group having 1 to 18 carbon atoms, or an alkoxy group having 1 to 18 carbon atoms. Each of X, X , Y, and Y is —O—, —CO—, —NH—, or —NR— (R is an alkyl group having 1 to 4 carbon atoms). A⁺ represents hydrogen, sodium ion, potassium ion, ammonium ion, or aliphatic ammonium ion.)

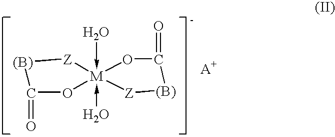

(wherein M represents a metal in the center of coordination, which is Cr, Co, Ni, Mn, Fe, Ti, Zr, Zn, Si, B or Al. (B) represents

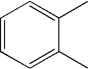

(which may have a substituent such as an alkyl group),

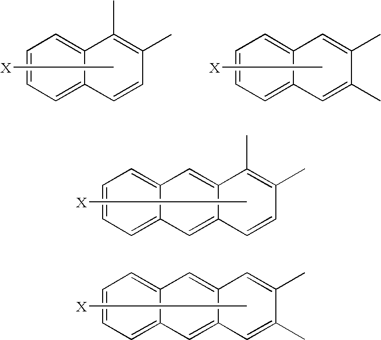

(where X is a hydrogen atom, a halogen atom, or a nitro group) and

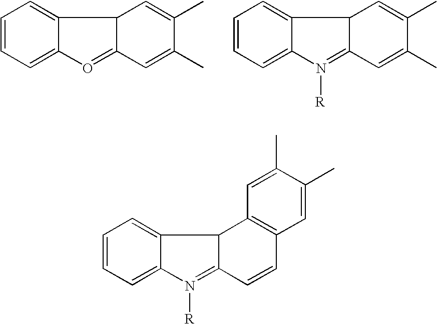

(where R is a hydrogen atom, an alkyl group of C₁ to C₁₈, or an alkenyl group of C₂ to C₁₈).

A′⁺ represents hydrogen, sodium ion, potassium ion, ammonium ion, or aliphatic ammonium ion.

Z is 0-, or

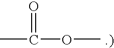

Of those, the azo type metal complex represented by the formula (I) is more preferable. Above all, an azo type iron complex represented by the following formula (III) or (IV), in which the central metal is Fe is most preferable.

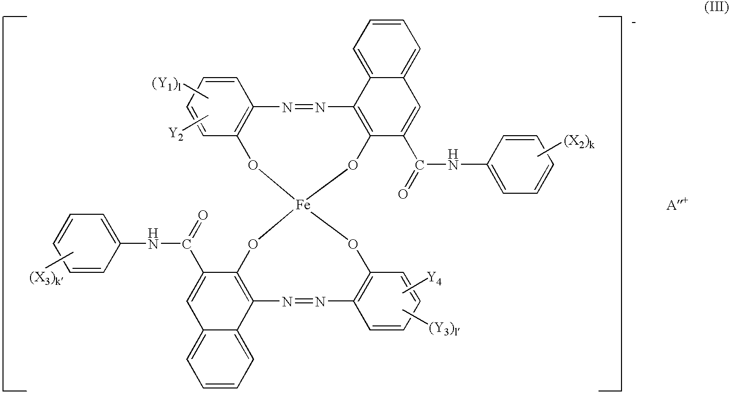

(wherein each of X₂ and X₃ represents a hydrogen atom, a lower alkyl group, a lower alkoxy group, a nitro group, or a halogen atom; each of k and k′ represents an integer number of 1 to 3; each of Y₁ and Y₃ represents a hydrogen atom, an alkyl of C1 to C18, an alkenyl of C2 to C18, sulfonamide, mesyl, sulfonic acid, a carboxy ester, hydroxy, an alkoxy of C1 to C18, acetylamine, benzoyl, an amino group, or a halogen atom; each of l and l′ represents an integer number of 1 to 3; each of Y₂ and Y₄ represents a hydrogen atom, or a nitro group (the above X₂ and X₃, k and k′, Y₁ and Y₃, l and l′, and Y₂ and Y₄, may be identical to or different from each other); A″⁺ represents ammonium ion, sodium ion, potassium ion, hydrogen ion, or mixed ions thereof, and preferably comprises 75 to 98 mole % of ammonium ion.)

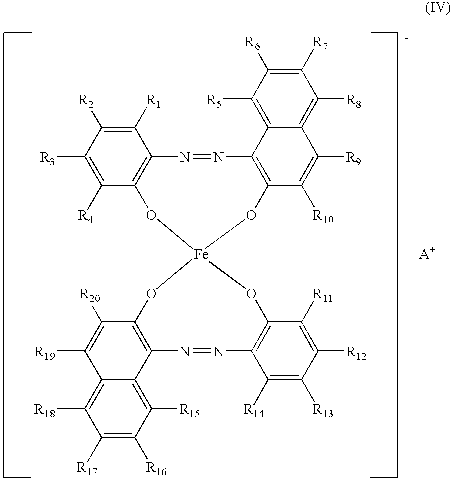

(wherein each of R₁ to R₂₀ represents hydrogen, halogen, or an alkyl group; A⁺ represents ammonium ion, sodium ion, potassium ion, hydrogen ion, or mixed ions thereof.)

Next, specific examples of the azo type iron complex represented by the above formula (III) are represented as (1) to (6).

azo Type Iron Complex Compound (1)

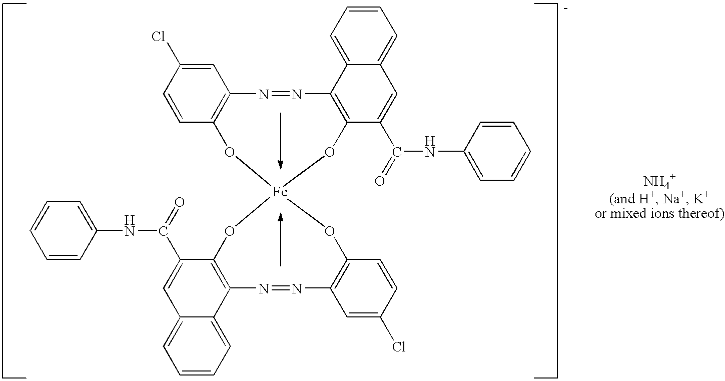

azo Type Iron Complex Compound (2)

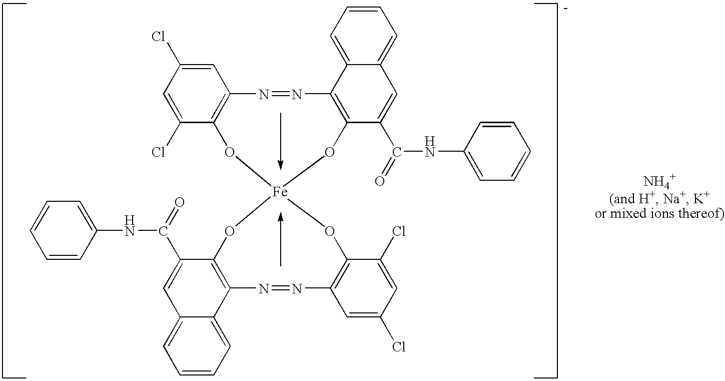

azo Type Iron Complex Compound (3)

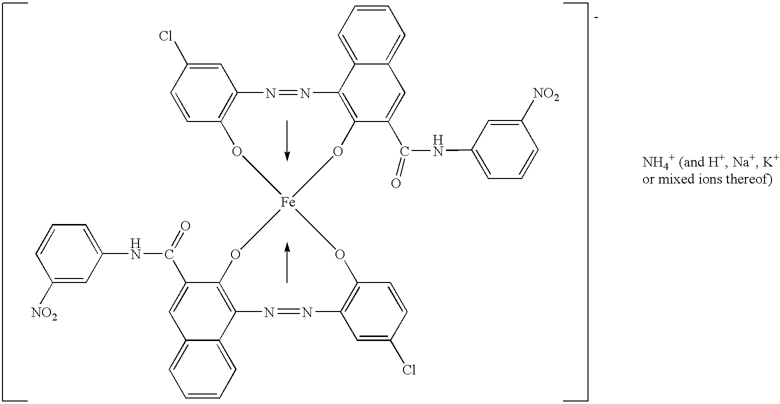

azo Type Iron Complex Compound (4)

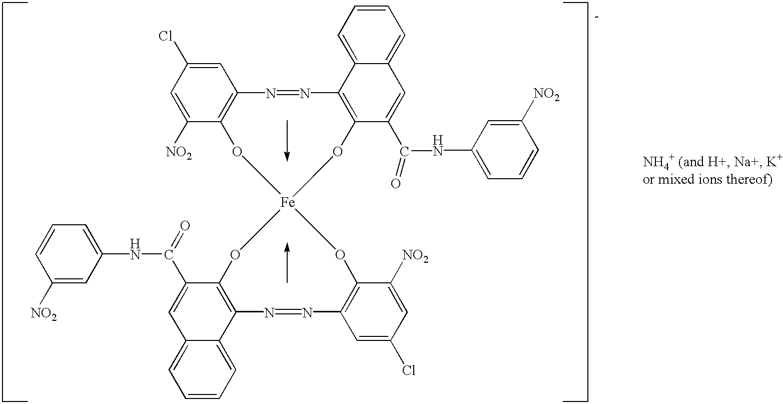

azo Type Iron Complex Compound (5)

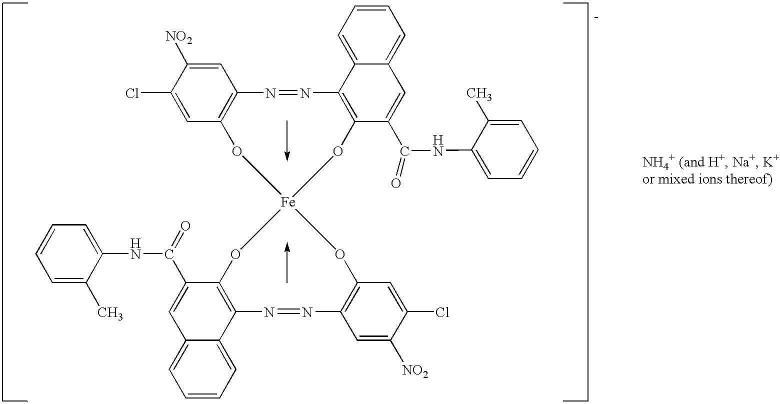

azo Type Iron Complex Compound (6)

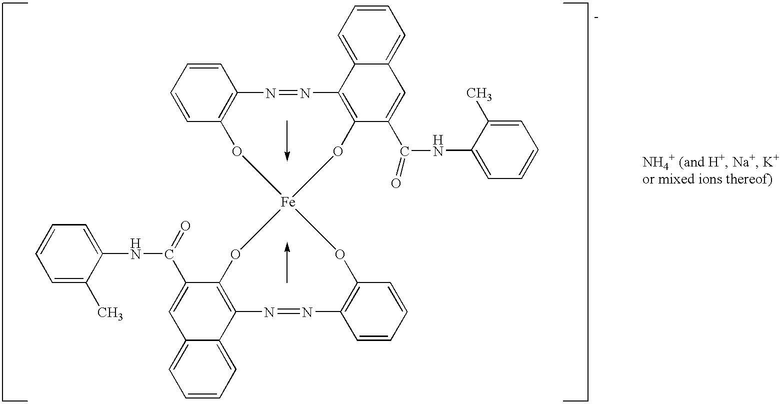

Further, specific examples of the charge controlling agent represented by the above formulas (I), (II), and (IV) are represented as (7) to (13) below.

azo Type Iron Complex Compound (7)

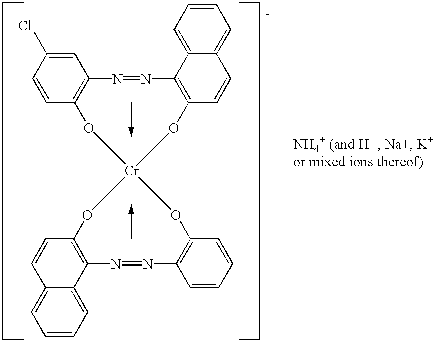

azo Type Iron Complex Compound (8)

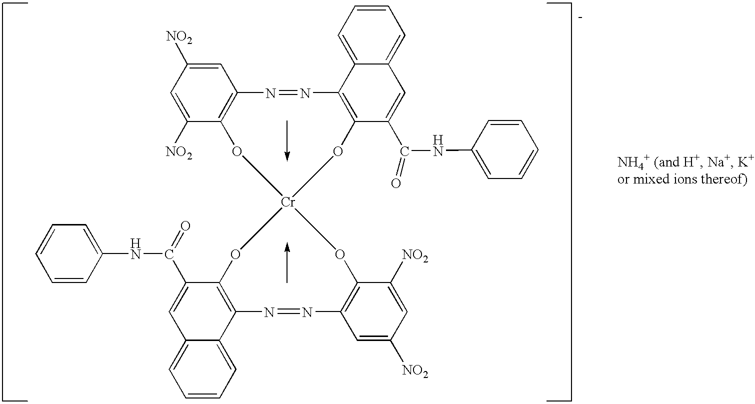

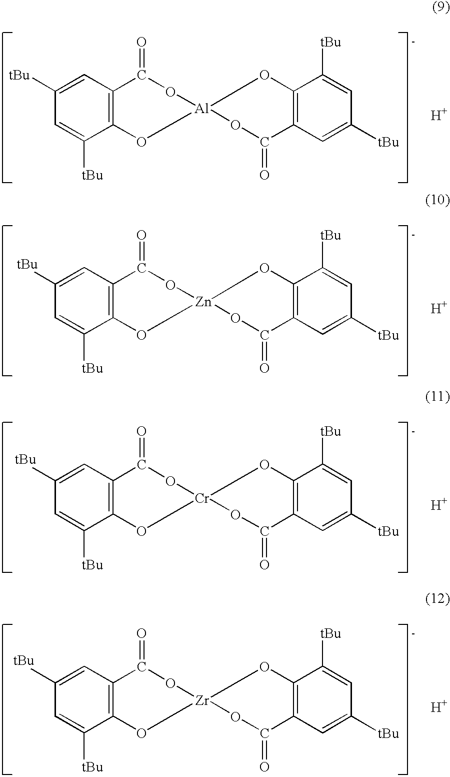

azo Type Iron Complex Compound (13)

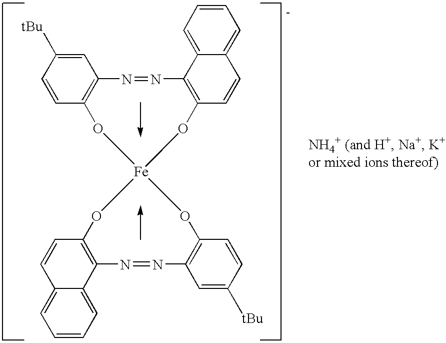

Those metal complex compounds may be used separately or two or more types thereof may also be used in combination. In terms of charge amount of the toner, the usage amount of those charge controlling agents is preferably 0.1 to 5.0 parts by mass with respect to 100 parts by mass of the binder resin.

On the other hand, materials for controlling the toner into a positive charge type are given below. Materials modified by nigrosine and metallic salts of fatty acid; quaternary ammonium salts such as tributylbenzylammonium-1-hydroxy-4-naphthosulfonate, and tetrabutylammonium tetrafluoroborate and onium salts such as phosphonium which are analogs thereof, and lake colors thereof; triphenylmethane dye and lake colors thereof (examples of the lake activating agent include phosphotungstic acid, phosphomolybdic acid, phosphotungsten molybdic acid, tannic acid, lauric acid, gallic acid, ferricyanide, and ferrocyanide); metallic salts of higher fatty acids; diorganotin oxides such as dibutyltin oxide, dioctyltin oxide, and dicyclohexyltin oxide; and diorganotin borates such as dibutyltin borate, dioctyltin borate, and dicyclohexyltin borate can be given. Those may be used separately or two or more types thereof may also be used in combination.

Furthermore, it is preferable that an inorganic fine powder or a hydrophobic inorganic fine powder be mixed with the toner of the present invention. For example, it is preferable that a silica fine powder be added to toner particles to be used as toner.

As the silica fine powder used in the present invention, dry silica, which is called dry-type or fumed silica generated by oxidation in a vapor phase of a silicon halogen compound, and so-called wet silica produced from water glass or the like can be used. The dry silica, which contains a small number of silanol groups on its surface and inside, and produces little production residues, is preferable.

Furthermore, the silica fine powder used in the present invention is preferably treated so as to be hydrophobic. The silica fine powder is made hydrophobic by being chemically treated with an organic silicon compound that reacts with or physically adsorbs to the silica fine powder. A preferable method is as follows: after a dry silica fine powder generated by oxidation of a silicon halogen compound in a vapor phase is treated with a silane compound or at the same time as that the dry silica fine powder is treated with a silane compound, the dry silica fine powder is treated with an organic silicon compound such as silicone oil.

Examples of the silane compound used in the hydrophobizing process include hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilanemercaptan, trimethylsilylmercaptan, triorganosilylacrylate, vinyldimethylacetoxysilane, dimethylethoxysilane, dimethyldimethoxysilane, diphenyldiethoxysilane, hexamethyldisiloxane, 1,3-divinyltetramethyldisiloxane, and 1,3,-diphenyltetramethyldisiloxane.

As the organic silicon compound, silicone oil can be given. A preferable silicone oil used is one which has a viscoisty of approximately 3×10⁻⁵ to 1×10⁻³m²/sec at 25° C. For example, dimethyl silicone oil, methylhydrogen silicone oil, methylphenyl silicone oil, α-methylstyrene modified silicone oil, chlorophenyl silicone oil, fluorine modified silicone oil, and the like are preferable.

As a method for treatment with silicone oil, for example, silica fine powder treated with a silane compound and silicone oil may be directly mixed using a mixer such as a Henschel mixer, or silicone oil may be injected to silica as a base. Alternatively, silicone oil is dissolved or dispersed in an appropriate solvent and mixed with a silica fine powder as a base, and the solvent is removed.

In the toner of the present invention, an external additives other than a silica fine powder may be added to toner particles, if required.

Examples of the external additives include resin fine particles and inorganic fine particles that function as a charging adjuvant, an electroconductivity-imparting agent, a flowability-imparting agent, an anti-caking agent, a lubricant, an abrasive, and the like.

For example, lubricants such as polyethylene fluoride, zinc stearate, and polyvinylidene fluoride are preferable. Of those, polyvinylidene fluoride is preferable. Abrasives such as cerium oxide, silicon carbide, and strontium titanate are preferable. Of those, strontium titanate is preferable. For example, a flowability-imparting agent such as titanium oxide or aluminum oxide is preferable. Of those, a hydrophobic agent is preferable. An anti-caking agent, or an electroconductivity-imparting agent such as carbon black, zinc oxide, antimony oxide, or tin oxide, and a white fine powder and a black fine powder with reversed polarity may be used in a small amount as a development enhancer.

The inorganic fine powder or hydrophobic inorganic fine powder to be mixed with toner particles is preferably used in an amount of 0.1 to 5 parts by mass (preferably 0.1 to 3 parts by mass) with respect to 100 parts by mass of toner particles.

In order to produce the toner of the present invention, a mixture at least containing a binder resin, a magnetic iron oxide, and a colorant is used as a material. In addition to this, a charge controlling agent, other additives and the like are used, if required. Those materials are thoroughly mixed by a mixer such as a Henschel mixer or a ball mill, melted, wedged, and kneaded by using a thermal kneader such as a roller, a kneader, or an extruder to dissolve resins in each other, and a pigment or a dye is dispersed or dissolved in the mixture, followed by solidification by cooling. Thereafter, the resultant mixture was crushed, classified, and the like to obtain toner.

Examples of the mixer include: Henschel mixer (manufactured by Mitsui Mining Co., Ltd.); Super mixer (manufactured by Kawata MFG. Co., Ltd.); Riboconne (manufactured by Okawara MFG. Co., Ltd.); Nauta mixer, Turbulizer mixer, and Cycromix (manufactured by Hosokawa Micron Co., Ltd.); Spiral pin mixer (manufactured by Pacific Machinery & Engineering Co., Ltd.); and Redige mixer (manufactured Matsubo Co., Ltd.). Examples of the kneader include: KRC kneader (manufactured by Kurimoto Ironworks Co., Ltd.); Buss-Co-Kneader (manufactured by BUSS Co., Ltd.); TEM extruder (manufactured by Toshiba Machine Co., Ltd.); TEX biaxial kneader (manufactured by Japan Steel Works Co., Ltd.); PCM kneader (manufactured by Ikegai Steelworks Co., Ltd.); Three roll mill, Mixing roll mill, and Kneader (manufactured by Inoue MFG Co., Ltd.); Kneadex (manufactured by Mitsui Mining Co., Ltd.); MS type pressurizing kneader, and Kneadaruder (manufactured by Moriyama MFG Co., Ltd.); and Banbury mixer (manufactured by Kobe Steel Co., Ltd.). Examples of the pulverizer include: Counter jet mill, Micro jet mill, and Inomizer (manufactured by Hosokawa Micron Co., Ltd.); IDS type mill, and PJM jet pulverizer (manufactured by Japan Pneumatic Co., Ltd.); Crossjet Mill (manufactured by Kurimoto Ironworks Co., Ltd.); Urumax (manufactured by Nisso Engineering Co., Ltd.); SK Jet-O-Mill (manufactured by Seisin Enterprise Co., Ltd.); Cliptron (manufactured by Kawasaki Heavy Industries); Turbo Mill (manufactured by Turbo Kogyou Co., Ltd.); and Super rotor (manufactured by Nissin Engineering Co., Ltd.). Examples of the classifier include: Classiel, Micron Classifier, and Spedic Classifier (manufactured by Seisin Enterprises Co., Ltd.); Turbo Classifier (manufactured by Nisshin Engineering Co., Ltd.); Micron separator, Turboplex (ATP), and TSP Separator (manufactured by Hosokawa Micron Co., Ltd.); Elbow-Jet (manufactured by Nittetsu Mining Co., Ltd.); Dispersion Separator (manufactured by Japan Pneumatic Co., Ltd.); and YM Microcut (manufactured by Yasukawa Electric Co., Ltd.). Examples of the screening device for sifting a coarse particle include: Ultra Sonic (manufactured by Koei MFG Co., Ltd.); Resona Sieve, and Gyro Sifter (manufactured by Tokujyu Kousakusho Co., Ltd.); Vibrasonic System (manufactured by Dalton Co., Ltd.); Soniclean (manufactured by Sintokogio Co., Ltd.); Turbo Screener (manufactured by Turbo Kogyo Co., Ltd.); Micro Sifter (manufactured by Makino MFG Co., Ltd.); and Circular Oscillation Screens.

### EXAMPLES

The basic configuration and characteristics of the present invention have been described above. Hereinafter, the present invention will be described more specifically on the basis of examples. However, embodiments of the present invention are not limited by the following description. The term part in Examples refers to part by mass. Table 1 shows resins used in Examples. Table 2 shows wax. Table 3 shows magnetic iron oxide. A styrene resin was synthesized by solution polymerization, and a polyester resin was synthesized by dehydration and condensation. A magnetic iron oxide was produced as follows.

(Production Example 1 of Magnetic Iron Oxide)

Sodium silicate was added to a ferrous sulfate aqueous solution so that the content of a silicon element was 0.48% with respect to that of an iron element. After that, a sodium hydroxide aqueous solution was mixed to the solution to prepare an aqueous solution containing ferrous hydroxide. Air was blown into the resultant aqueous solution while the pH thereof was adjusted to 10. An oxidation reaction was performed at 80° C. to 90° C., whereby a slurry liquid generating a seed crystal was prepared.

After the generation of the seed crystal was confirmed, a ferrous sulfate aqueous solution was further added to the slurry liquid appropriately. Then, air was blown into the resultant mixture while the pH of the slurry liquid was adjusted to 10, whereby an oxidation reaction was performed. During the reaction, while the concentration of unreacted ferrous hydroxide and the proceeding ratio of the reaction were checked, zinc sulfate was appropriately added to the mixture. Furthermore, the pH of the aqueous solution was adjusted in stages, such as 9 in an initial stage of the reaction, 8 in the middle stage of the reaction, and 6 in the final stage of the reaction, whereby the distribution of a metal element in a magnetic iron oxide was controlled to complete the oxidation reaction.

The generated magnetic iron oxide was washed and dried through filtration in accordance with a conventional method. Primary particles of the resultant magnetic iron were aggregated to form an aggregate. The aggregate of the magnetic iron oxide was provided with a compression force and a shearing force using Mixmerer to crack the aggregate, whereby the magnetic iron oxide was made into primary particles, and the surface of each magnetic iron oxide was made smooth. Thus, magnetic iron oxide 1 having the characteristics as shown in Table 3 was obtained.

(Production Example 2 of Magnetic Iron Oxide)

A magnetic iron oxide 2 having the physical properties shown in Table 3 was obtained in the same way as in Production Example 1, except that the added amounts of sodium silicate and zinc sulfate were changed, and aluminum sulfate was added.

(Production Examples 3 to 5 of Magnetic Iron Oxide)

Magnetic iron oxides 3 to 5 having the physical properties shown in Table 3 were obtained in the same way as in Production Example 1, except that the added amounts of sodium silicate and zinc sulfate were changed.

(Production Example 6 of Magnetic Iron Oxide)

Sodium silicate was added to a ferrous sulfate aqueous solution so that the content of a silicon element was 0.40% with respect to that of an iron element. After that, a sodium hydroxide aqueous solution was mixed to the solution to prepare an aqueous solution containing ferrous hydroxide. Air was blown into the resultant aqueous solution while the pH thereof was adjusted to 10. An oxidation reaction was performed at 80° C. to 90° C., whereby a slurry liquid generating a seed crystal was prepared.

After the generation of the seed crystal was confirmed, a ferrous sulfate aqueous solution was further added to the slurry liquid appropriately. Then, air was blown into the resultant mixture while the pH of the slurry liquid was adjusted to 10, whereby an oxidation reaction was performed. During the reaction, while the concentration of unreacted ferrous hydroxide and the proceeding ratio of the reaction were checked, zinc sulfate was appropriately added to the solution. Furthermore, the pH of the aqueous solution was adjusted to 8 to complete the oxidation reaction.

The generated magnetic iron oxide was washed and dried through filtration in accordance with a conventional method. Primary particles of the resultant magnetic iron oxide were aggregated to form an aggregate. The aggregate of the magnetic iron oxide was provided with a compression force and a shearing force using Mixmerer to crack the aggregate, whereby the magnetic iron oxide was made into primary particles, and the surface of each magnetic iron oxide was made smooth. Thus, magnetic iron oxide 6 having the characteristics as shown in Table 3 was obtained.

(Production Example 7 of Magnetic Iron Oxide)

A magnetic iron oxide 7 having the physical properties shown in Table 3 was obtained in the same way as in Production Example 6, except that the added amounts of sodium silicate and zinc sulfate were changed.

(Production Example 8 of Magnetic Iron Oxide)

A sodium hydroxide aqueous solution was mixed to a ferrous sulfate aqueous solution to prepare an aqueous solution containing ferrous hydroxide. Air was blown into the resultant aqueous solution while the pH thereof was adjusted to 10. An oxidation reaction was performed at 80° C. to 90° C., whereby a slurry liquid generating a seed crystal was prepared.

After the generation of the seed crystal was confirmed, a ferrous sulfate aqueous solution was further added to the slurry liquid appropriately. Then, air was blown into the resultant mixture while the pH of the slurry liquid was adjusted to 10, whereby an oxidation reaction was performed. During the reaction, while the concentration of unreacted ferrous hydroxide and the proceeding ratio of the reaction were checked, zinc sulfate was appropriately added. Furthermore, while the pH of the aqueous solution was adjusted to 8, the oxidation reaction was once completed. Then, sodium silicate was added to a ferrous sulfate aqueous solution so that the content of a silicon element would be 1.10% with respect to an iron element to prepare an aqueous solution. This aqueous solution was added to the above-mentioned reaction slurry, and the pH of the aqueous solution was adjusted to 8 to complete the oxidation reaction.

The generated magnetic iron oxide was washed and dried through filtration in accordance with a conventional method. Primary particles of the resultant magnetic iron oxide were aggregated to form an aggregate. The aggregate of the magnetic iron oxide was provided with a compression force and a shearing force using Mixmerer to crack the aggregate, whereby the aggregate were made into primary particles, and the surface of each magnetic iron oxide was made smooth. Thus, magnetic iron oxide 8 having the characteristics as shown in Table 3 was obtained.

TABLE 1
Binder resin

| | Composition of | Composition | | | Acid value |
|---|---|---|---|---|---|
| | monomer | ratio | Tg | Mw/Mn | (mgKOH/g) |
| Binder | Styrene | 78.0 parts | 59° C. | 27.4 | 3.5 |
| resin A | n-butylacrylate | 20.0 parts | | | |
| | Mono-n-butylmaleate | 1.5 parts | | | |
| | Divinylbenzene | 0.5 parts | | | |
| Binder | Styrene | 74.5 parts | 61° C. | 23.1 | 14.2 |
| resin B | n-butylacrylate | 20.0 parts | | | |
| | Mono-n-butylmaleate | 5.0 parts | | | |
| | divinylbenzene | 0.5 parts | | | |
| Binder | PO-BPA | 70 mol | 57° C. | 17.6 | 18 |
| resin C | EO-BPA | 30 mol | | | |
| | TPA | 90 mol | | | |
| | TMA | 40 mol | | | |
| Binder | PO-BPA | 61 mol | 58° C. | 30.3 | 30 |
| resin D | EO-BPA | 26 mol | | | |
| | FA | 43 mol | | | |
| | TMA | 17 mol | | | |
| Binder | PO-BPA | 70 mol | 57° C. | 25.5 | 22 |
| resin E | EO-BPA | 33 mol | | | |
| | TPA | 28 mol | | | |
| | TMA | 30 mol | | | |
| | APA | 38 mol | | | |
| Binder | EO-BPA | 90 mol | 58° C. | 18.9 | 42 |
| resin F | TPA | 70 mol | | | |
| | TMA | 27 mol | | | |
| | SA | 27 mol | | | |

EO-BPA: Bisphenol A EO adduct
PO-BPA: Bisphenol A PO adduct
TPA: Terephthalic acid
TMA: Trimellitic anhydride
FA: Fumaric acid
APA: Adipic acid
SA: Dodecenylsuccinic acid

TABLE 2
Wax

| | | melting |
|---|---|---|
| | Composition | point (° C.) |
| Wax a | Polypropylene wax | 140 |
| Wax e | Polyethylene wax | 100 |
| Wax c | Parafine wax | 73 |
| Wax d | Fisher-Tropsch wax | 110 |
| Wax b | Higher alcohol wax | 100 |

TABLE 3
Magnetic iron oxide

| | Content of | Content of | | | | | | | | | |
|---|---|---|---|---|---|---|---|---|---|---|---|
| | all Si | all Zn | Concentration of atoms | | | | Element ratio on | | | Particle | |
| | (% by | (% by | on an outermost surface (%) | | | | an outermost surface | | | size | BET |
| | mass) | mass) | Si | Zn | Fe | Others | Zn/Si | Fe/Si | Fe/Zn | (μm) | (m²/g) |
| Magnetic iron oxide 1 | 0.50 | 0.57 | 14.3 | 3.1 | 80.7 | 1.9 | 0.22 | 5.64 | 26.0 | 0.21 | 9.6 |
| Magnetic iron oxide 2 | 0.50 | 0.29 | 16.3 | 1.3 | 79.7 | 2.7 | 0.08 | 4.89 | 61.3 | 0.20 | 10.4 |
| Magnetic iron oxide 3 | 1.06 | 0.42 | 17.3 | 6.7 | 74.4 | 1.6 | 0.39 | 4.30 | 11.1 | 0.20 | 9.3 |
| Magnetic iron oxide 4 | 1.98 | 3.30 | 16.8 | 4.5 | 76.2 | 2.5 | 0.27 | 4.54 | 16.9 | 0.21 | 9.6 |
| Magnetic iron oxide 5 | 0.61 | 2.49 | 15.2 | 6.6 | 73.8 | 4.4 | 0.43 | 4.85 | 11.2 | 0.24 | 9.2 |
| Magnetic iron oxide 6 | 0.41 | 4.88 | 18.6 | 3.1 | 61.5 | 16.8 | 0.17 | 3.31 | 19.8 | 0.19 | 15.1 |
| Magnetic iron oxide 7 | 0.02 | 0.03 | 0.01 | 0.02 | 97.3 | 2.67 | 0.50 | 9730 | 4865 | 0.25 | 9.1 |
| Magnetic iron oxide 8 | 1.00 | 1.50 | 16.8 | 0.8 | 79.8 | 2.60 | 0.048 | 4.75 | 99.75 | 0.22 | 9.8 |

### Example 1

| | |
|---|---|
| Binder resin C | 100 parts |
| Magnetic iron oxide 1 | 90 parts |
| Wax b | 4 parts |
| Charge controlling agent C | 2 parts |

The above-mentioned mixture was melt-kneaded by a twin extruder heated to 140° C. Then, the cooled kneaded mixture was roughly crushed with a hammer mill. The roughly crushed mixture was finely crushed with a jet mill. The fine crushed powder thus obtained was classified by a fixed-wall type air classifier to generate a classified powder. Furthermore, an ultra-fine powder and a coarse powder were accurately removed by classification from the classified powder thus obtained at the same time, using a multi-division classification (Elbow Jet Classifier manufactured by Nittetsu Mining. Co., Ltd.) using the Coanda effect, whereby negatively charged magnetic toner particles with a weight-average particle size (D4) of 6.7 μm were obtained.

Then, 1.2 parts of a hydrophobic silica fine powder with a methanol wettability of 80% and a BET specific surface area of 120 m²/g, treated so as to be hydrophobic with 15% by mass of hexamethyldisilazane and 15% by mass of dimethyl silicone, and 1.0 part of strontium titanate were externally mixed with 100 parts of the toner particles thus obtained, whereby toner 1 was prepared.

Table 4 shows internally addition prescription of the toner.

The toner 1 was subjected to a print test of 20,000 sheets under the condition that a commercially available LBP printer (LBP-950, manufactured by Canon Inc.) was remodeled to have a print speed of 1.5 times of that before remodeling, in environments of 15° C. and 10% RH, 23° C. and 60% RH, and 30° C. and 80% RH.

The image density was obtained by subjecting an image with a side of 5 mm to reflection density measurement, using an SPI filter with a Macbeth densitometer (manufactured by Macbeth Co.). Fogging was measured using a reflection densitometer (Reflectmeter model TC-6DS, manufactured by Tokyo Denshoku Co. Ltd.), and fogging was evaluated with Ds-Dr as a fogging amount, where Ds represents a white portion reflection density worst value after image formation, and Dr represents a reflection average density of a transfer material before image formation. A smaller numerical value exhibits better fogging suppression. Those evaluations were performed, at initial stage, after endurance of 20,000 sheets, and after left to stand outside of the device for one day.

The consumption amount of the toner was obtained as follows. Imaging was performed in 1,000 sheets at room temperature and normal humidity (23° C., 60% RH), using the above-mentioned device for imaging test. After that, a latent image line width was set at 420 μm with a 10-dot horizontal line pattern of 600 dpi, imaging with a printing ratio of 4% was performed in 5,000 sheets with A4 size, and the consumption amount of toner was determined from the change in the amount of the toner in a developer.

The rising of a charge amount was evaluated in accordance with the intermittent print test was performed. In the print test, imaging of a horizontal line pattern in which 4-dot horizontal lines were printed every 176 dot spaces was performed at a rate of one sheet per 10 seconds in an environment of 15° C. and 10% RH, using an image forming device obtained by remodeling the laser beam printer LBP-1760 manufactured by Canon Inc. to increase its printing speed from 16 sheets/minute to 24 sheets/minute. Then, an image with a side of 5 mm was sampled from the 1st, 3rd, 7th, 15th, 50th, and 100th sheets, and each image density was measured. The rising of a charge amount is considered to be faster when a high image density is obtained from the early imaging pages.

Image quality was evaluated as follows. Imaging of isolated 1-dot patterns of 1200 dpi was performed at room temperature and normal humidity (23° C., 60% TH), using an image forming device obtained by remodeling the laser beam printer LBP-1760 manufactured by Canon Inc. to increase its printing mode from 16 sheets/minute to 24 sheets/minute, and an image was observed with an optical microscope to evaluate the reproducibility of dots. The evaluation standards were as follows.

A: Toner does not extend off a latent image at all, and dots are reproduced completely.

B: A small amount of toner extends off a latent image.

C: A large amount of toner extends off a latent image.

Trailing was evaluated as follows. Imaging of a pattern in which 4-dot horizontal lines were printed in a 20-dot space was performed using the imaging test device, and the number of trailing on a line was counted. The evaluation standards were as follows.

A: No trailing

B: Less than 3

C: 3 to less than 7

D: 7 to less than 15

E: 15 or more

### Examples 2-7

### Comparative Examples 1-3

Toners 2 to 10 were produced in the same way as in Example 1 in accordance with the prescription described in Table 4, and were subjected to the same test as that in Example 1. Tables 5 to 9 show the test results.

TABLE 4
Prescription of toners

| | Example | Example | Example | Example | Example | Example | Example | Comparative | Comparative | Comparative |
|---|---|---|---|---|---|---|---|---|---|---|
| | 1 | 2 | 3 | 4 | 5 | 6 | 7 | Example 1 | Example 2 | Example 3 |
| Toner No. | 1 | 2 | 3 | 4 | 5 | 6 | 7 | 8 | 9 | 10 |
| Binder | C | B | A | D | F | B | C | A | E | F |
| resin | | | | | | | | | | |
| Charge | C | B | C | A | B | A | C | A | B | C |
| controlling | | | | | | | | | | |
| agent | | | | | | | | | | |
| Wax | b | c | E | d | a | d | b | a | C | e |
| Magnetic | 1 | 2 | 3 | 2 | 4 | 1 | 5 | 6 | 7 | 8 |
| iron oxide | | | | | | | | | | |

The charge controlling agents shown in Table 4 used in Examples and Comparative Examples are as follows.

Charge Controlling Agent A

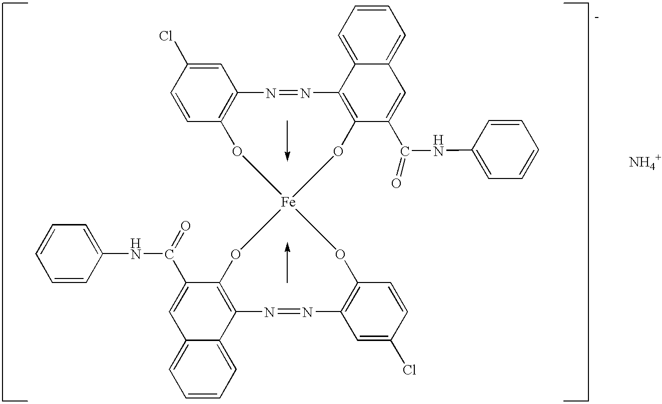

Charge Controlling Agent B

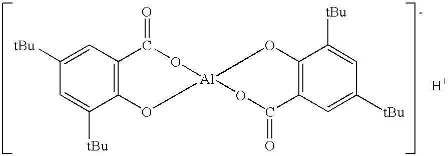

Charge Controlling Agent C

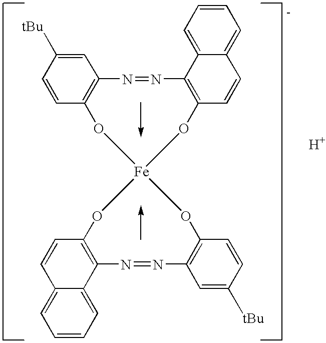

TABLE 5
Results of evaluations of each toner under high temperature and
high humidity environment (30° C., 80% RH)

| | | | After endurance | | After left to | |
|---|---|---|---|---|---|---|
| | Initial | | of 20,000 sheets | | stand | |
| | Image | | Image | | Image | |
| | density | Fogging | density | Fogging | density | Fogging |
| Example 1 | 1.47 | 1.1 | 1.45 | 1.3 | 1.44 | 1.2 |
| Example 2 | 1.41 | 1.3 | 1.40 | 1.5 | 1.39 | 1.8 |
| Example 3 | 1.44 | 2.1 | 1.41 | 2.5 | 1.37 | 2.5 |
| Example 4 | 1.45 | 0.9 | 1.44 | 1.1 | 1.43 | 1.1 |
| Example 5 | 1.46 | 2.1 | 1.45 | 2.3 | 1.44 | 2.2 |
| Example 6 | 1.44 | 1.0 | 1.42 | 1.2 | 1.39 | 1.2 |
| Example 7 | 1.44 | 2.0 | 1.40 | 2.3 | 1.36 | 2.0 |
| Comparative | 1.42 | 1.9 | 1.40 | 2.3 | 1.25 | 2.0 |
| Example 1 | | | | | | |
| Comparative | 1.27 | 2.5 | 1.20 | 2.8 | 1.15 | 2.9 |
| Example 2 | | | | | | |
| Comparative | 1.38 | 2.3 | 1.33 | 2.5 | 1.21 | 2.4 |
| Example 3 | | | | | | |

TABLE 6
Results of evaluations of each toner under room temperature and ordinary
humidity environment (23° C., 60% RH)

| | | | After endurance | | After left to | | Consumption |
|---|---|---|---|---|---|---|---|
| | Initial | | of 20,000 sheets | | stand | | amount of |
| | Image | | Image | | Image | | toner |
| | density | Fogging | density | Fogging | density | Fogging | (mg/sheet) |
| Example 1 | 1.47 | 1.9 | 1.45 | 2.3 | 1.43 | 2.4 | 38 |
| Example 2 | 1.40 | 2.2 | 1.40 | 2.5 | 1.39 | 2.6 | 41 |
| Example 3 | 1.39 | 1.9 | 1.38 | 2.4 | 1.38 | 2.4 | 36 |
| Example 4 | 1.43 | 1.0 | 1.41 | 1.2 | 1.41 | 1.4 | 42 |
| Example 5 | 1.42 | 2.5 | 1.40 | 2.9 | 1.40 | 2.9 | 35 |
| Example 6 | 1.41 | 1.4 | 1.39 | 1.5 | 1.38 | 1.6 | 40 |
| Example 7 | 1.42 | 2.8 | 1.41 | 3.3 | 1.40 | 3.1 | 37 |
| Comparative | 1.40 | 3.6 | 1.38 | 4.5 | 1.35 | 4.5 | 48 |
| Example 1 | | | | | | | |
| Comparative | 1.25 | 2.7 | 1.20 | 3.3 | 1.16 | 3.5 | 23 |
| Example 2 | | | | | | | |
| Comparative | 1.39 | 2.7 | 1.37 | 3.0 | 1.33 | 4.7 | 47 |
| Example 3 | | | | | | | |

TABLE 7
Results of evaluations of each toner under low temperature
and low humidity environment (15° C., 10% RH)

| | | | After endurance | | After left to | |
|---|---|---|---|---|---|---|
| | Initial | | of 20,000 sheets | | stand | |
| | Image | | Image | | Image | |
| | density | Fogging | density | Fogging | density | Fogging |
| Example 1 | 1.49 | 2.0 | 1.48 | 2.3 | 1.47 | 2.3 |
| Example 2 | 1.41 | 2.3 | 1.42 | 2.8 | 1.40 | 2.7 |
| Example 3 | 1.39 | 2.1 | 1.44 | 2.9 | 1.37 | 2.5 |
| Example 4 | 1.45 | 1.1 | 1.45 | 1.2 | 1.44 | 1.1 |
| Example 5 | 1.40 | 2.9 | 1.37 | 3.1 | 1.36 | 3.0 |
| Example 6 | 1.44 | 1.5 | 1.42 | 2.5 | 1.42 | 2.5 |
| Example 7 | 1.43 | 3.0 | 1.42 | 3.3 | 1.41 | 3.2 |
| Comparative | 1.41 | 3.8 | 1.42 | 4.5 | 1.37 | 4.5 |
| Example 1 | | | | | | |
| Comparative | 1.25 | 3.0 | 1.20 | 3.3 | 1.18 | 3.5 |
| Example 2 | | | | | | |
| Comparative | 1.38 | 3.5 | 1.33 | 4.0 | 1.26 | 4.1 |
| Example 3 | | | | | | |

TABLE 8
Evaluation of rising of a charge amount

| | Under low temperature and low humidity | | | | | |
|---|---|---|---|---|---|---|
| | enviroment (15° C., 10% RH) | | | | | |
| | first | third | 7th | 15th | 50th | 100th |
| | sheet | sheet | sheet | sheet | sheet | sheet |
| Example 1 | 1.45 | 1.42 | 1.40 | 1.44 | 1.48 | 1.49 |
| Example 2 | 1.42 | 1.35 | 1.35 | 1.37 | 1.39 | 1.40 |
| Example 3 | 1.40 | 1.35 | 1.33 | 1.37 | 1.39 | 1.41 |
| Example 4 | 1.43 | 1.44 | 1.42 | 1.45 | 1.45 | 1.45 |
| Example 5 | 1.41 | 1.38 | 1.37 | 1.39 | 1.40 | 1.40 |
| Example 6 | 1.45 | 1.37 | 1.39 | 1.41 | 1.42 | 1.44 |
| Example 7 | 1.43 | 1.40 | 1.37 | 1.37 | 1.38 | 1.39 |
| Comparative | 1.40 | 1.32 | 1.35 | 1.35 | 1.38 | 1.39 |
| Example 1 | | | | | | |
| Comparative | 1.26 | 1.15 | 1.15 | 1.13 | 1.15 | 1.16 |
| Example 2 | | | | | | |
| Comparative | 1.35 | 1.30 | 1.30 | 1.36 | 1.33 | 1.33 |
| Example 3 | | | | | | |

TABLE 9
Evaluation of image quality

| | Reproducibility | |
|---|---|---|
| | of minute dots | Trailing |
| Example 1 | A | A |
| Example 2 | A | B |
| Example 3 | B | C |
| Example 4 | A | A |
| Example 5 | B | C |
| Example 6 | A | B |
| Example 7 | B | C |
| Comparative | C | E |
| Example 1 | | |
| Comparative | C | E |
| Example 2 | | |
| Comparative | C | D |
| Example 3 | | |

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A magnetic toner comprising at least a binder resin and a magnetic iron oxide,
wherein the magnetic iron oxide contains Si in an amount of 0.1 to 2.0% by mass with respect to the magnetic iron oxide and Zn in an amount of 0.1 to 4.0% by mass with respect to the magnetic iron oxide,
a concentration of Si atoms is 12.50 to 17.50%, a concentration of Fe atoms is 70.00 to 85.00%, and a concentration of Zn atoms is 1.00 to 7.00% on an outermost surface of the magnetic iron oxide, measured by an X-ray photoelectron spectroscopy (XPS), and
a Zn/Si ratio is 0.05 to 0.5, a Fe/Si ratio is 3.00 to 7.00, and a Fe/Zn ratio is 10.00 to 70.00 on an outermost surface of the magnetic iron oxide.

2. A magnetic toner according to claim 1, wherein
the magnetic iron oxide contains Si in an amount of 0.3 to 1.8% by mass with respect to the magnetic iron oxide and Zn in an amount of 0.1 to 4.0% by mass with respect to the magnetic iron oxide.

3. A magnetic toner according to claim 1, wherein
the magnetic iron oxide contains Zn in an amount of 0.1 to 2.0% by mass with respect to the magnetic iron oxide.

4. A magnetic toner according to claim 1, wherein the binder resin is polyester resin having an acid value of 1 to 100 mgKOH/g.
